(19) United States
(12) Patent Application Publication
(10) Pub. No.: US 2006/0217020 A1
(43) Pub. Date: Sep. 28, 2006

(54) Single-layer waterproof insulating system

(76) Inventor: Michael J. McGinley, Bellevue, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/305,879

(22) Filed: Dec. 16, 2005

Related U.S. Application Data
(63) Continuation of application No. 10/196,093, filed on Jul. 17, 2002, now abandoned.

(51) Int. Cl. B32B 5/18; B32B 5/24; B32B 5/26

(52) U.S. Cl. 442/221; 428/315.5; 428/315.9; 442/224; 442/225; 442/226; 442/370; 442/373; 442/374

(57) ABSTRACT

A single-layer waterproof insulating system that is totally waterproof, windproof and an insulating high performance fabric for textile products or garments such as coats, jackets, vests, pants, blankets, hats, caps, gloves, etc., composed of three separate panels: a waterproof outer panel; a middle micro-cell membrane thermal wall film panel of polyurethane; an inner panel; wherein the three panels are sealed by the process of a permanent bond by laminating the three panels together with a permanent adhesive producing a single-layer fabric that blocks water from penetrating the insulating system, thereby providing a wearer both warmth and protection from moisture and wind.

### CROSS-REFERENCE TO RELATED APPLICATION

This application is a continuation of U.S. patent application Ser. No. 10/196,093, filed Jul. 17, 2002, now pending, which application is incorporated herein by reference in its entirety.

### BACKGROUND OF THE INVENTION

1. Field of the Invention

The present invention relates to a single-layer insulating system, particularly to a totally waterproof and windproof insulating high performance fabric for textile products or garments such as coats, jackets, vests, pants, blankets, hats, caps, gloves, etc., comprising three separate panels: a waterproof outer panel; a middle micro-cell membrane thermal wall film panel of polyurethane; an inner panel; wherein the three panels are sealed by the process of a permanent bond by laminating the three panels together with a permanent adhesive producing a single-layer fabric that blocks water from penetrating the insulating system, thereby providing a wearer both warmth and protection from moisture and wind.

2. Description of the Related Art

Various outdoor activities, such as camping, hiking, hunting, etc. involve spending much time outdoors, and exposing the wearer's body to different climatic conditions, often in cold, windy and wet weather.

Traditional outerwear garments are designed to wear in layers; often are bulky, heavy, and noisy.

Wool jackets for warmth soaked through quickly and wool is not waterproof nor windproof, vinyl rain coats hindered movement; and the material, for example known commercially by the trademark “Gore-Tex” owned by the company W.L. Gore Ass. Inc. (Elkton, Md.), made too much noise, and such material has to be seam-sealed and reprocessed to maintain breathability and waterproofness; however, such material is not warm, insulating, and 100% waterproof.

Under pressure, “Gore-Tex” material will let water in through the fabric, for example at the elbows and knees when bending and kneeling or if pressure is applied, such as sitting on the fabric, carrying a heavy backpack in the rain, etc.

Dissimilar seam tape, applied to seams in seam sealing, often separates over a garment's life expectancy, thereby causing the seam to leak, i.e., becoming non-waterproof.

Membrane material, of the type commonly known as “Gore Tex,” becomes brittle and can easily break, rip or tear in subzero temperatures.

Another material, for example known commercially by the trademark “Gore Windstopper” owned by the company W.L. Gore Ass. Inc., creates a microclimate for the wearer, whereby body heat is recirculated rather than released by having a breathable membrane; however, such material is not totally waterproof.

A different material, for example known commercially by the trademark “Epic” owned by Nextec, is a highly water resistant, wind protective and chemically treated encapsulated fabric; however, such material is not insulating and non-laminated.

What is needed is a means for providing a warm and insulating waterproof and windproof high performance fabric that lends light weight comfort, durability, and quietness to the wearer in the outdoor arena without becoming brittle, nor break, rip or tear in subzero temperature, thereby making the single-layer insulating waterproof and windproof fabric much better for both performance and survival.

U.S. Patent Publication No. 2001/0034897, issued as U.S. Pat. No. 6,397,401, describes a two-layer firefighter insulating garment system having an outer layer and a trilaminate inner layer of about 6 ounces per square yard of Basofil blend kit, vapor-permeable moisture membrane, e.g., Stedair 2000, and 2 ounces per square yard of Nomex knit sewn together used to manufacture fire retardant or firefighting textile products.

U.S. Pat. No. 6,112,332, issued Sep. 5, 2000, describes an insulated liner for a headgear assembly that includes a flexible cap and an insulator adapted to increase the heat retention of the cap.

U.S. Pat. No. 6,041,437, issued Mar. 28, 2000, describes a waterproof thermal insert for outdoor sport pants. The waterproof thermal insert is sewn into the rear of a pair of pants from the belt line to the region between the middle of the thigh to the back of the knee. The insert having three layers: an inner layer of fleece, a middle layer of thermal insulating fabric, and an outer layer of water repellant, closed cell foam neoprene.

U.S. Pat. No. 5,860,163, issued Jan. 19, 1999, describes a garment thermal inner having insulating beads. The thermal liner includes a fabric substrate and layer of lightweight insulating beads bonded to substrate airspace.

None of the above inventions and patents, taken together or singly describes the present invention as claimed or address to a single-layer insulating system that is both waterproof and windproof.

### BRIEF SUMMARY OF THE INVENTION

The present invention is a single layer waterproof and windproof insulating system used in high performance fabrics for textile products or garments such as coats, jackets, vests, pants, blankets, hats, caps, gloves, etc.

The insulating system is composed of three panels: (1) an outer waterproof panel; (2) a micro-cell membrane thermal wall; and (3) an inner panel; wherein said panels are sealed by the process of a permanent bond by laminating the three panels together with a permanent adhesive, producing a single-layer that blocks water from penetrating the insulating system, thereby providing warmth and protection for the wearer from both moisture and wind.

The principal object of the invention to provide a single layer insulating waterproof and windproof system that is non-seam sealed to prevent water from pushing through the fabric.

Another object of the invention is to alleviate the need for layering of additional garments to create warmth for the wearer.

Still another object of the invention is to alleviate the need to wear bulky clothing by providing a single light weight and comfortable high performance fabric while outdoors against rain, snow, sleet, wind, and cold, thereby eliminating the need to have a separate insulating liner garment from a waterproof garment.

A further object of the invention is to provide a durable high performance fabric that has a tensile strength and puncture strength greater than material of the type commonly known as “Gore-Tex.”

A still further object of the invention is to have as a base exterior fabric of polyester, whose properties will not absorb water, moisture, humidity or other types of various liquids; and whose properties create a more durable fabric from other fabrics such as nylons.

Another object of the invention is to simplify and maintain the basic properties of fabrics using a thermal harrier that is consistent with base fabrics, i.e., minimal breathability, whereby products do not have to be:

1) Reprocessed or washed in a special way to reopen the micropores for breathability during fabric's life expectancy to achieve optimum claims/objectives such as breathability;

2) Have performance characteristics in extreme temperatures that other films cannot achieve, such as “Gore-Tex,” which becomes stiff and brittle; and

3) Maintain the fabric's performance over the life expectancy of the textile product with no deterioration.

Another object of the invention is to eliminate the need for seam tape on finished products since seam tape will separate well prior to the garment's life expectancy and affect its overall waterproofness.

Another object of the invention is to achieve a stronger overall finished waterproof fabric that is much more durable and stronger than what is currently offered in the waterproof and so-called “breathable” fabrics by using polyester fabrics as the base panel layers on each side of the micro-cell membrane thermal wall film, thereby achieving a much stronger and more durable finished fabrics than others using nylons as an outside layer.

Still another object of the invention is to provide a high performance fabric that is quiet in the hunting and outdoor arena.

### BRIEF DESCRIPTION OF THE SEVERAL VIEWS OF THE DRAWINGS

FIG. 1 is a detail view of a portion of the waterproof and windproof single-layer insulating system according to the present invention.

### DETAILED DESCRIPTION OF THE INVENTION

The present invention is a durable, light weight, quiet, waterproof and windproof single-layer insulating system used in high performance fabrics for textile products or garments such as coats, jackets, vests, pants, blankets, hats, caps, gloves, etc.

While the invention originated for hunters during climbing, crawling, or walking, the single-layer waterproof and windproof insulating system is also useful for all other outdoor activities involving the wearer exposure to the elements.

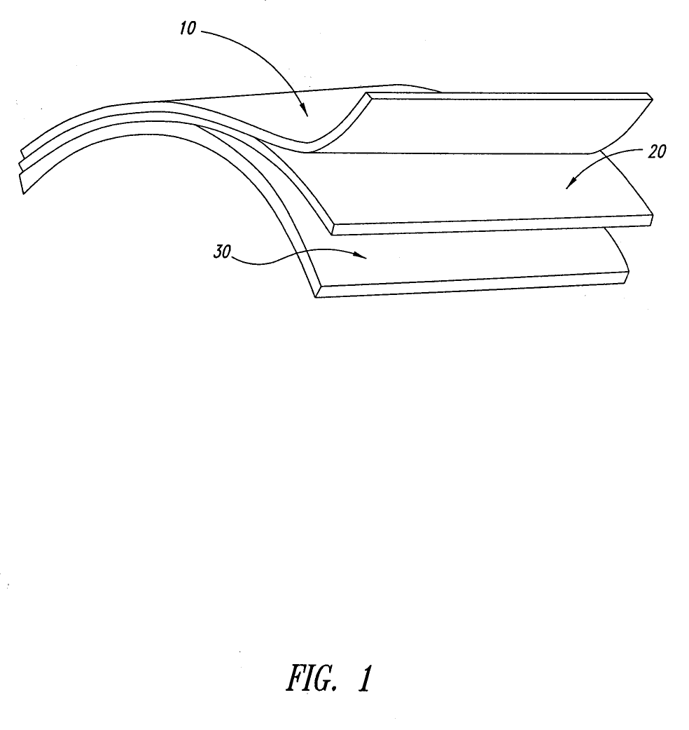

FIG. 1 shows the single-layer waterproof and windproof insulating system is a thin layer of an impermeable micro-film 20 fused between an outer panel shell 10 and an inner panel lining 30.

The single layer waterproof and windproof insulating system forms a thermal wall between the wearer and the outdoor elements, keeping the body warm, dry, and insulated regardless of the outside conditions.

The micro-cell membrane thermal wall film 20 has a thickness of 1 mm to 1.5 mm of polyurethane film.

The outer panel 10 is composed of an exterior fabric panel with a Durable Water Repellant (DWR) finish to prevent the exterior face fabric of the outer panel 10 from wetting out, the act of absorbing water and becoming heavy, and gives the outer panel 10 fabric dirt and stain resistance.

The outer panel 10 consists of various synthetic and non-synthetic fabrics, both woven and non-woven, including polyester fleece, camouflaged printed pattern fleece, or micro-fleece.

The inner panel 30 is composed of various synthetic and non-synthetic fabrics, woven or non-woven, including polyester such as fleece, micro-fleece, or other materials having similar characteristics.

The outer panel 10 is cured with a permanent adhesive to the micro-cell membrane wall film 20, pressed, then, the outer panel and micro-cell membrane thermal wall film rolled onto the inner panel.

In order to preserve the waterproof properties, the outer panel 10 combined with the DWR finish tends to keep water out of fabric by filling in needle holes when sewing of the waterproof and windproof single-layer insulating system product.

Sewing threads are soaked in silicone before sewing the product in order to increase the waterproof properties of seams.

The threads become highly water repellant, filling needle holes along with the fleece fibers.

Polyester has a natural tendency to not to expand, but rather to close around needle holes, unlike nylon.

Polyester is also a stronger fabric, having a more dense fabric weave overall than nylon, properties of which do not lend itself to easy breathability, but substantially increases overall durability of the finished textile product or garment compared to others.

The waterproof and windproof properties of the single layer insulating system traps body heat while allowing body vapor to be trapped away from the wearer into areas between million of fleece fibers of the inner panel 30.

The single-layer waterproof and windproof insulating system prevents convective heat loss by preventing warm air displacing with cold air in the microclimate next to the wearer's skin.

1. A garment system to substantially insulate a wearer, the system comprising:
a waterproof outer panel having one of synthetic fabrics and non-synthetic fabrics;
an inner panel comprising a fleece material; and
a middle panel having a water-impermeable micro-cell membrane thermal wall film with a thickness in the range of 1.0-1.5 mm, the middle panel being adhered directly onto the outer panel with a permanent adhesive, the outer panel and middle panel being adhered directly onto the inner panel with the permanent adhesive to form a fused, flexible, single layer laminated system, wherein the laminated system retains body heat while allowing body vapor to be at least substantially trapped by the fleece material of the inner panel.

2. The garment system according to claim 1 wherein the outer panel further comprises a durable water repellant face finish.

3. The garment system according to claim 1 wherein the water-impermeable middle panel is comprised of polyurethane.

4. The garment system according to claim 1 wherein the waterproof outer panel is comprised of polyester.

5. The garment system according to claim 1, further comprising:
a water repellent applied to the outer panel to achieve a desired amount of water impermeability of the outer panel.

6. A garment system to substantially insulate a wearer, the system comprising:
an outer panel comprising a first fabric;
an inner panel comprising a fleece fabric; and
a middle panel comprising a thermally-insulating polyurethane film, the middle panel located between the outer panel and the inner panel, the middle panel adhered directly to the outer panel and to the inner panel, wherein the adhered panels comprise a laminated system in which the inner panel traps at least some amount of body vapor in the fleece material and away from the wearer, the middle panel substantially, thermally insulates the wearer, and the outer panel substantially prevents exterior moisture from infiltrating to the middle panel.

7. The garment system of claim 6 wherein the first fabric is a synthetic fabric.

8. The garment system of claim 6 wherein the first fabric is a non-synthetic fabric.

9. The garment system of claim 6 wherein the first fabric comprises polyester fleece.

10. The garment system of claim 6, further comprising:
a water repellent applied to the outer panel to achieve a desired amount of water impermeability of the outer panel.
